(19) United States
(12) Patent Application Publication
(10) Pub. No.: US 2023/0355469 A1
(43) Pub. Date: Nov. 9, 2023

(54) CHEST COMPRESSION APPARATUS AND METHOD

(71) Applicants: KELSIE VOKES, EASTON, PA (US); BRIDGET VOKES, BRIDGEWATER, NJ (US)

(72) Inventors: KELSIE VOKES, EASTON, PA (US); BRIDGET VOKES, BRIDGEWATER, NJ (US)

(21) Appl. No.: 17/738,045

(22) Filed: May 6, 2022

(51) Int. Cl. A61H 31/00

(52) U.S. Cl. CPC A61H 31/007; A61H 2201/0153; A61H 2201/0134; A61H 2201/0157; A61H 2201/0161; A61H 2201/1253; A61H 2201/1635

(57) ABSTRACT

A compression apparatus for supporting the inside of the dominant hand of a person administering cardiopulmonary resuscitations to a patient in order to increase the quality and effectiveness of compressions, as well as comfort to the person performing compressions comprising: a first layer; a second layer; and a third layer fixed and aligned together; and a strap attached to the first layer. The first and third layers are typically made of foam; and the second layer is made of a material which is more rigid than the foam of the first and third layers. The apparatus is configured so that the palm of the dominant hand administering cardiopulmonary resuscitations simultaneously fits at least partially between the strap in the closed state and a top surface of the first layer, while at least part of a palm of the dominant hand rests on the first layer top surface.

### FIELD OF THE INVENTION

This invention relates to chest compression devices and methods concerning cardiopulmonary resuscitation (CPR).

### BACKGROUND OF THE INVENTION

There are various known chest compression devices and methods concerning cardiopulmonary resuscitation (CPR). Traditionally when administering CPR, the person performing chest compressions uses their bare hands. There are devices that can mechanically administer CPR, but these devices are expensive (commonly used in ambulances). It is not practical to have these expensive devices in all hospitals. When administering CPR to a patient, it is common for the person who is performing chest compressions to experience pain and discomfort after long periods of time, which can impact the quality of compressions. There needs to be a way to allow healthcare workers to more effectively administer CPR. It would be beneficial to have a device to protect the hands of the person administering CPR so that they are able to perform quality compressions for a longer period of time. This is especially important in times when there is a shortage of healthcare workers, and therefore less people available to perform CPR.

### SUMMARY OF THE INVENTION

At least one embodiment of the present invention, provides a compression apparatus that is used to act as a barrier between the hand of the person administering CPR (the compressor) and the patient's chest. It attaches to the dominant hand of the person administering CPR with an adjustable Velcro (trademarked) strap. It is designed to cover the inside palm of the dominant hand of the person administering CPR.

In at least one embodiment, the apparatus is preferably made up of a sandwich of three layers. The top layer is composed substantially or entirely of foam to cushion the hand of the person administering CPR. The middle layer is a lightweight semi-rigid plastic material, and the bottom layer is another layer of foam to protect the skin of the patient receiving CPR.

This is an affordable way to improve the quality of chest compressions so that healthcare workers are able to perform effective compressions for longer periods of time without experiencing pain.

If provided to non-medical individuals responding to a cardiac arrest, i.e. along with an AED (automated external defibrillator device) this device will help them provide higher quality chest compressions while awaiting emergency personnel.

In at least one embodiment, an apparatus is provided for supporting the inside of the dominant hand of a person administering cardiopulmonary resuscitation to a patient in order to increase the quality and effectiveness of compressions, as well as comfort to the person performing compressions comprising: a first layer; a second layer; a third layer; and a strap protruding through and/or attached to the first layer.

In at least one embodiment, the first, second and third layers are fixed together, are aligned with each other, and the second layer is sandwiched between the first and the third layers; the first and third layers are made of foam; the second layer is made of a material which is more rigid than the foam of the first and the third layers; and the strap is configured to be placed in an open state or in a closed state.

In at least one embodiment, the apparatus is configured so that second-fifth digits of the compressor's dominant hand are slid under the strap so that the hand is secured between the first layer of the apparatus and the strap. The strap will rest either on top of or proximal to the knuckles on the dorsal surface of the dominant hand. The person's palm will rest on the first layer of the device.

The second layer may be made of a lightweight semi-rigid plastic material. The first layer may have a top surface area with a width of about 5.0 inches and a length of about 3.5 inches. The top surface of the first layer may have a printed arrow which points towards the strap, and which is critical in one or more embodiments, to designate proper insertion and/or placement of the person's palm between a closed strap and a sandwich of the first, second, and third layers.

In at least one embodiment, a method is provided for applying cardiopulmonary resuscitation compressions with a compression apparatus, which includes an adjustable strap, and a sandwich of first, second, and third layers, wherein the method comprises: in a first state, locating four non thumb fingers of a person's hand at least partially between the strap in a closed state and the sandwich of first, second, and third layers, while simultaneously locating a palm of the person's hand at least partially on a top surface of the first layer; and in the first state, having the person apply cardiopulmonary resuscitation compressions to a patient by pressing down with the person's hand on a top surface of the first layer of the sandwich, while a bottom surface of the third layer is at least partially in contact with the patient's chest; and wherein the second layer is sandwiched between the first and the second layers.

The compression apparatus may be constructed as previously described. The first, second, and third layers may have substantially the same area and are aligned with each other and fixed together.

### BRIEF DESCRIPTION OF THE DRAWINGS

FIG. 1 is a front, left, and top perspective view of a chest compression apparatus in accordance with an embodiment of the present invention, with a strap of the chest compression apparatus shown in a closed state wherein a first part of the strap is attached to a second part of the strap;

FIG. 2 is a front, right, and bottom perspective view of the chest compression apparatus of FIG. 1, with the strap in the closed state;

FIG. 3 is a front elevational view of the chest compression apparatus of FIG. 1, with the strap in the closed state;

FIG. 4 is a rear elevational view of the chest compression apparatus of FIG. 1, with the strap in the closed state;

FIG. 5 is a left side elevational view of the chest compression apparatus of FIG. 1, with the strap in the closed state;

FIG. 6 is a right side elevational view of the chest compression apparatus of FIG. 1, with the strap in the closed state;

FIG. 7 is a top plan view of the chest compression apparatus of FIG. 1, with the strap in the closed state;

FIG. 8 is a bottom plan view of the chest compression apparatus of FIG. 1, with the strap in the closed state;

FIG. 9 is a front, left, and top perspective view of the chest compression apparatus of FIG. 1 with the strap in an open state in which the first part of the strap is detached from the second part of the strap;

FIG. 10 is a front, left, and top perspective view of a chest compression apparatus of FIG. 1, with THE strap of the chest compression apparatus shown in a closed state wherein a first part of the strap is attached to a second part of the strap; and with four fingers of a hand shown in dashed lines inserted between the strap and a top surface of the chest compression apparatus, and a thumb of the hand shown at least partially on the top surface of the chest compression apparatus;

FIG. 11 is a bottom plan view of a foam piece or plate for use with the chest compression apparatus of FIG. 1; and

FIG. 12 is a bottom plan view of a hard plastic piece or plate for use with the chest compression apparatus of FIG. 1.

### DETAILED DESCRIPTION OF THE DRAWINGS

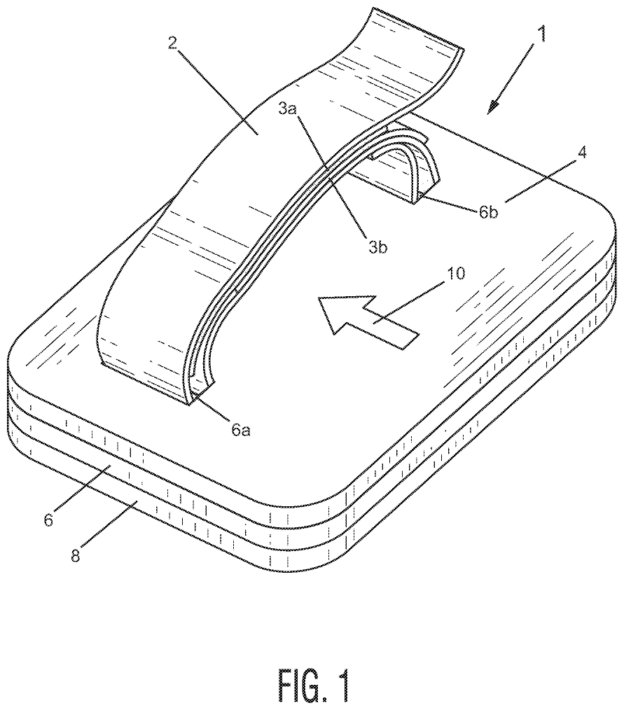

FIG. 1 is a front, left, and top perspective view of a chest compression apparatus 1 in accordance with an embodiment of the present invention, with a strap 2 of the chest compression apparatus 1 shown in a closed state wherein a first part of the strap 2 is attached to a second part of the strap 2. The first part of the strap is attached to, integrated with, and/or includes a Velcro (trademarked) or hooks and/or loops section 3a, which is detachably attached to the second part of the strap, which is attached to integrated with, and/or includes a Velcro (trademarked) or loops and/or hooks section 3b. The sections 3a and 3b are detachably connected and/or meshed together in FIG. 1.

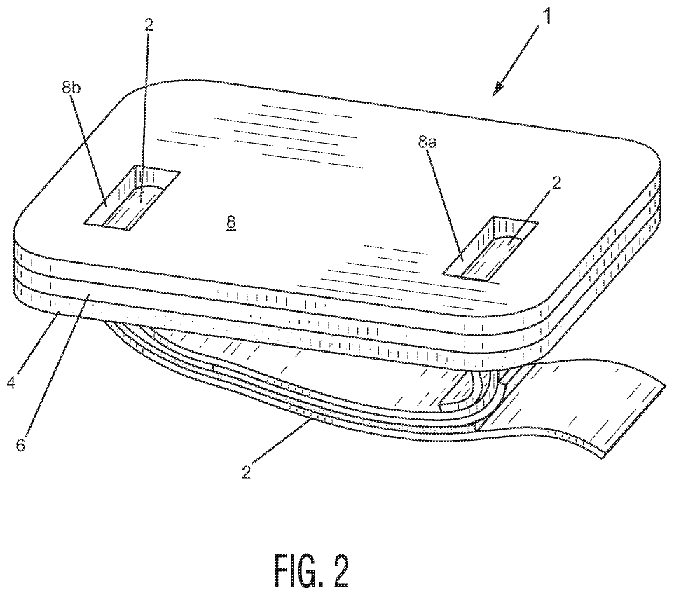

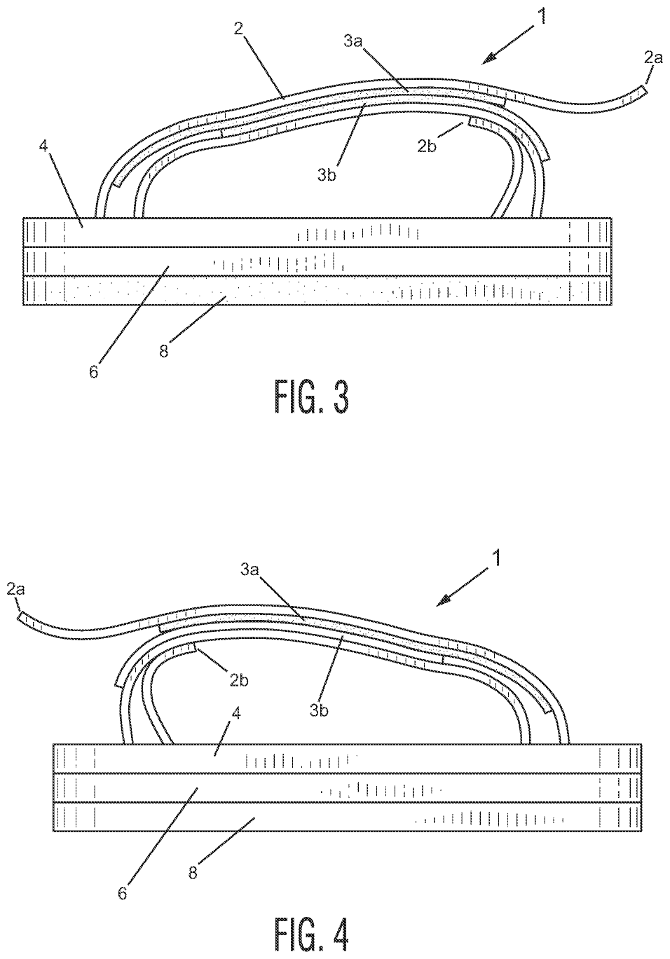

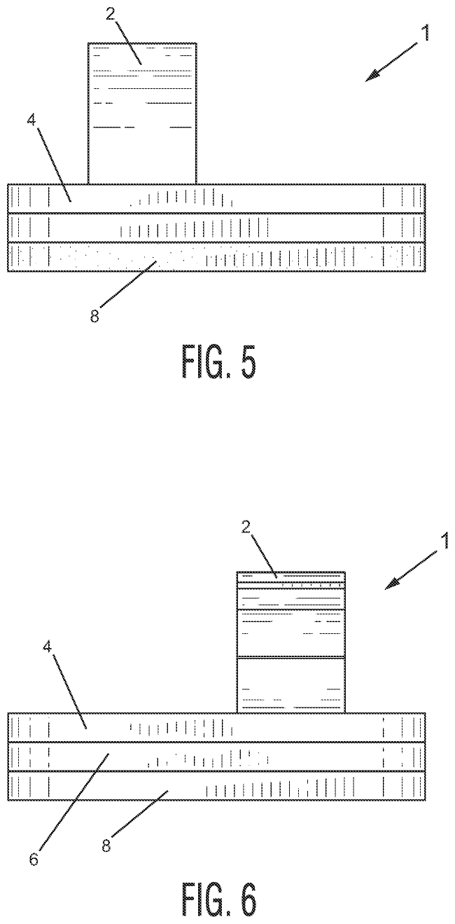

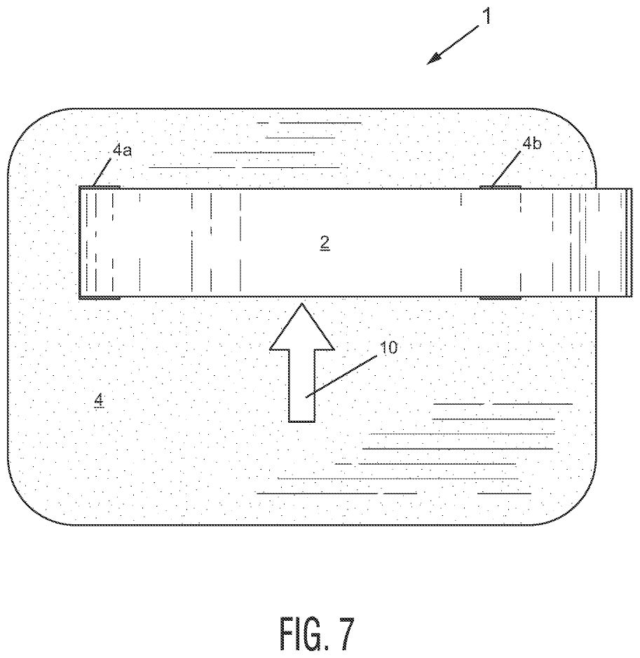

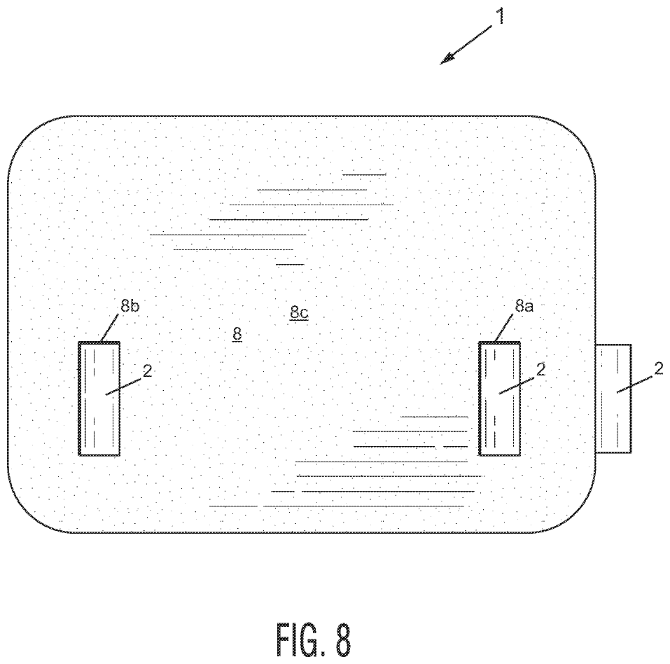

FIG. 2 is a front, right, and bottom perspective view of the chest compression apparatus 1 of FIG. 1, with the strap 2 in the closed state. FIG. 3 is a front elevational view of the chest compression apparatus 1 of FIG. 1, with the strap 2 in the closed state. FIG. 4 is a rear elevational view of the chest compression apparatus 1 of FIG. 1, with the strap 2 in the closed state. FIG. 5 is a left side elevational view of the chest compression apparatus 1 of FIG. 1, with the strap 2 in the closed state. FIG. 6 is a right side elevational view of the chest compression apparatus 1 of FIG. 1, with the strap 2 in the closed state. FIG. 7 is a top plan view of the chest compression apparatus 1 of FIG. 1, with the strap 2 in the closed state. FIG. 8 is a bottom plan view of the chest compression apparatus 1 of FIG. 1, with the strap 2 in the closed state.

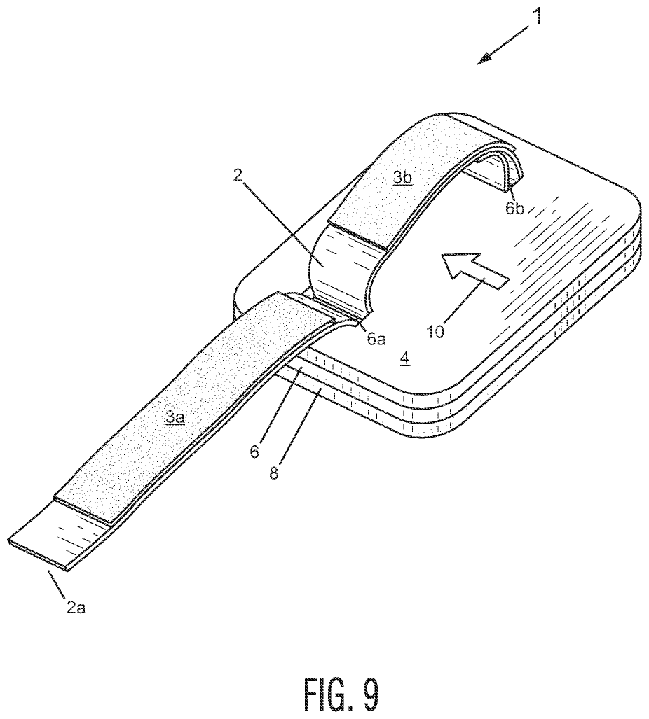

FIG. 9 is a front, left, and top perspective view of the chest compression apparatus 1 of FIG. 1 with the strap 2 in an open state in which the first part of the strap 1 is detached from the second part of the strap 2, such that hooks and/or loops section 3a is detached from loops and/or hoops section 3b.

Referring to FIGS. 1-9, the chest compression apparatus 1 includes a foam piece, plate or section 4, a rigid piece 6, which may be made of hard plastic, and a foam piece, plate or section 8, which may be identical to section 4.

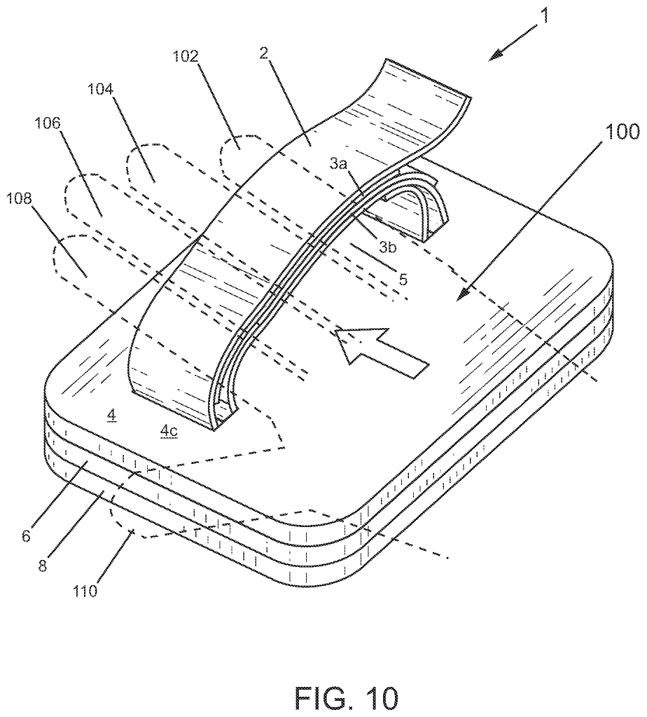

FIG. 10 is a front, left, and top′ perspective view of a chest compression apparatus 1 of FIG. 1, with the strap 2 of the chest compression apparatus 1 shown in a closed state wherein a first part of the strap 2 is attached to a second part of the strap 2; and with four, non thumb, fingers 102, 104, 106, and 108 of a hand 100 shown in dashed lines inserted between the closed strap 2 and a top surface 4c of the chest compression apparatus 1, and a thumb 110 of the hand 100 shown at least partially on the top surface 4c of the chest compression apparatus 1 and/or at least partially gripping the sides of one or more of sections 4, 6, and 8.

The section 4 has an arrow 10 imprinted on its top surface 4c, which is preferred to show from which direction four, non thumb fingers of a human hand, such as fingers 102, 104, 106, and 108 of hand 100 in FIG. 10, should be inserted through an area or region 5 between the closed strap 2 and the top surface 4c of the section 4, as shown by FIG. 10.

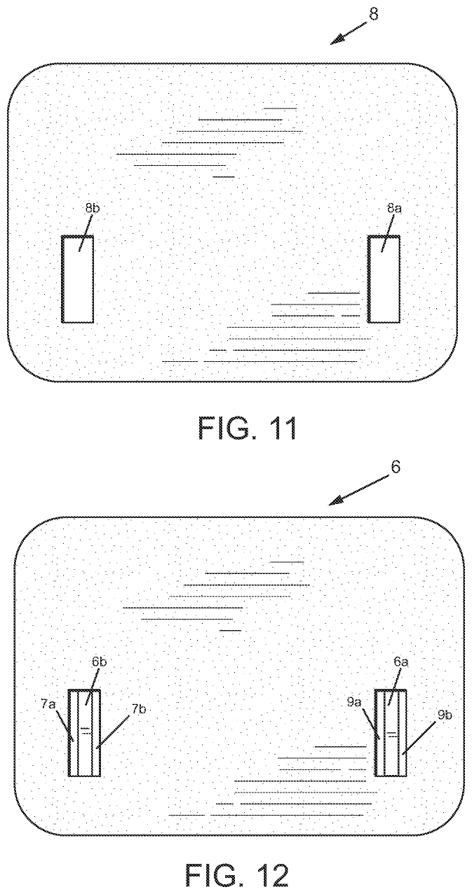

FIG. 11 is a bottom plan view of a foam piece or plate 8 for use with the chest compression apparatus 1 of FIG. 1. It is preferred, in at least one embodiment that the foam piece 8 be identical to the foam piece 4 for ease of manufacture, and in addition, a soft foam is preferred for both pieces 4 and 8 as will be described. The palm of the hand 100 rests on and/or comes in contact with the top surface 4c, and the palm of the hand 100 is used, in at least one embodiment to press downwards on the top surface 4c to apply chest compressions on a patient's chest, while the bottom surface 8c, shown in FIG. 8, or a substantial portion of the bottom surface 8c is in contact with the patient's chest.

The soft foam piece for section 4 reduces and/or eliminates the possibility that the person who is applying pressure with the palm of their hand 100 may hurt their hand, such as by pressing on a sharp rib or other sharp part of the patient's body.

The soft foam piece for section 8 reduces and/or eliminates the possibility that the patient will be hurt by the bottom surface 8c pressing on the patient's chest or other part of the patient's body.

Piece or section 8 includes openings 8a and 8b and piece or section 4, which may be identical or substantially the same as section 4, includes corresponding openings 4a and 4b.

FIG. 12 is a bottom plan view of a hard plastic piece and/or plate 6 for use with the chest compression apparatus 1 of FIG. 1. The piece or plate 6 includes a section 6b, and slots and/or elongated openings 7a and 7b. The piece or plate 6 also includes section 6a, and slots and/or elongated openings 9a and 9b.

In order to assemble the apparatus 1, at least one embodiment, an end 2b of the strap 2 may be first attached at section 6b of the piece 6, without piece 4 or 8. The end 2b of the strap 2 is inserted through slot 7b, passed underneath the bottom of section 6b, then through slot 7a to attach the end 2b at the location of section 6b. Next both strap ends 2a (which is opposite to 2b) and 2b may be passed through opening 4b in plate or section 4 shown in FIG. 7. Next, the end 2b may be attached, such as by gluing, back to part of strap 2 as shown in FIG. 3, to prevent the end 2b of the strap 2 from coming out of the location at section 6b.

Next, an end 2a of the strap 2, which opposes end 2b, is then inserted through opening 4a of plate or section 4, then through slot 9b of plate or section 6, passed underneath the bottom of section 6a, then through slot 9a, and back through opening 4a, to attach thereby attach end 2a at the location of section 6a. The section 4 can then be glued or otherwise permanently fixed to the section 6 in the orientation shown in FIG. 3. The section 8 can then be added onto the back of the section 6, and glued on, so that the sections 4, 6, and 8 are aligned with each other as shown by FIGS. 1-10. The openings 8a and 8b shown in FIG. 11, allow parts of the strap 2 to reside in the openings 8a and 8b to provide a smooth attachment of sections 8 and 6. The parts of strap 2 residing in the openings 8a and 8b are recessed in the openings 8a and 8b, so that the strap 2 does not contact the patient's chest, and only the soft bottom 8c of the section 8 contacts the patient's chest.

In operation, the sections 8, 6, and 4 of the apparatus 1 act as a barrier between the hand of a person administering CPR and a patient's chest. The apparatus 1 attaches to the dominant hand of the person administering CPR by use of strap 2. Strap 2 may typically be an adjustable Velcro (trademarked) strap. It is critical and preferable, in at least one embodiment, that the top surface area of the section 4 covers the inside palm of the dominant hand of the person administering CPR, wherein the inside palm of the dominant hand is placed on the top surface area of the section 4.

In at least one embodiment, the apparatus 1 is preferably It is made up of a sandwich of three layers 4, 6, and 8. The top layer or section 4 is comprised of substantially or entirely of foam to cushion the hand of the person administering CPR. The middle layer or section 6 is a lightweight semi-rigid plastic material, and the bottom layer or section 8 is another layer of foam to protect the skin of the person receiving CPR.

The apparatus 1 provides an affordable way to improve the quality of chest compressions so that healthcare workers are able to perform effective compressions for longer periods of time without experiencing pain.

If provided to non-medical individuals responding to a cardiac arrest (i.e. along with an AED (automated external defibrillator device) the apparatus 1 will help them to provide higher quality chest compressions while awaiting emergency personnel.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

We claim:

1. An apparatus for supporting the inside of the dominant hand of a person administering cardiopulmonary resuscitation to a patient in order to increase the quality and effectiveness of compressions, as well as comfort to the person performing compressions comprising:
a first layer;
a second layer;
a third layer; and
an adjustable strap protruding through the first layer;
wherein the first, second and third layers are fixed together, are aligned with each other, and the second layer is sandwiched between the first and the second layers;
wherein the first and third layers are made of foam;
wherein the second layer is made of a material which is more rigid than the foam of the first and the third layers; and
wherein the strap is configured to be placed in an open state or in a closed state; and
wherein the apparatus is configured so that the palm of the dominant hand of the person administering cardiopulmonary resuscitation simultaneously fits at least partially between the strap in the closed state and a top surface of the first layer, while at least part of a palm of the dominant hand rests on the top surface of the first layer.

2. The apparatus of claim 1 wherein
the second layer is made of a lightweight semi-rigid plastic material.

3. The apparatus of claim 1 wherein
the first layer has a top surface area with a width of about five inches and a length of about three and a half inches.

4. The apparatus of claim 1 wherein
the top surface of the first layer has an arrow which points towards the strap.

5. A method for applying cardiopulmonary resuscitation compressions with a compression apparatus, which includes a strap, and a sandwich of first, second, and third layers, wherein the method comprises:
in a first state, locating four non thumb fingers of a person's hand at least partially between the strap in a closed state and the sandwich of first, second, and third layers, while simultaneously locating a palm of the person's hand at least partially on a top surface of the first layer; and
in the first state, having the person apply cardiopulmonary resuscitation compressions to a patient by pressing down with the person's hand on a top surface of the first layer of the sandwich, while a bottom surface of the third layer is at least partially in contact with the patient's chest; and
wherein the second layer is sandwiched between the first and the second layers.

6. The method of claim 5 wherein
the first, second, and third layers have substantially the same area and are aligned with each other and fixed together.

7. The method of claim 5 wherein
the first and third layers are made of foam; and
wherein the second layer is made of a material which is more rigid than the foam of the first and the third layers.

8. The method of claim 7 wherein
the second layer is made of a lightweight semi-rigid plastic material

9. The method of claim 7 wherein
the first layer has a top surface area with a width of about five inches and a length of about three and half inches.

10. The method of claim 5 wherein
the top surface of the first layer has an arrow which points towards the strap.
